(19) United States
(12) Patent Application Publication
(10) Pub. No.: US 2004/0098414 A1
(43) Pub. Date: May 20, 2004

(54) Method, system, program product and DHTML-based interface for uploading files in a single posting

(75) Inventors: Wai Ho Chan, Quincy, MA (US); Vinod R. Seraphin, Westford, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/299,310

(22) Filed: Nov. 19, 2002

(51) Int. Cl. G06F 17/30

(52) U.S. Cl. 707/200

(57) ABSTRACT

An address corresponding to a first file to be uploaded is identified in a first file field displayed in a DHTML-based interface. Once identified, the address can be added to a list of uploads in the DHTML-based interface. After addition to the list, the first file field is hidden and a new, second file field is displayed. Once displayed, an address corresponding to a second file can be identified in the second file field and then added to the list of uploads. Both files can then be uploaded to a server or the like in a single posting.

### BACKGROUND OF THE INVENTION

1. Field of the Invention

The present invention generally relates to a method, system, program product and dynamic hypertext markup language-based (DHTML-based) interface for uploading files. Specifically, under the present invention, multiple files can be uploaded to a server or the like in a single “posting” using a DHTML-based interface.

2. Background Art

As the use of electronic messaging (e.g., electronic mail) has become prevalent, computer users are increasingly taking advantage of electronic messaging to perform tasks that previously required postal mail, facsimile machines, etc. One important feature of electronic messaging is the capability to “attach” files to electronic messages. Now, from the comfort of his/her desk, a sender can transmit an electronic message to an intended recipient along with any files/documents the sender wishes the intended recipient to receive. Given the rapid nature in which electronic messages travel, delivery which previously took days or weeks now takes seconds or minutes.

Heretofore, many systems have been developed for attaching files to electronic messages. Unfortunately, these previous systems have various drawbacks. For example, the attachment system implemented by the electronic mail service HOTMAIL.COM provides an interface that allows a sender to designate addresses of files he/she wishes to attach to an electronic mail message. However, the HOTMAIL.COM system individually uploads/posts each desired file to a mail server for attachment to the electronic mail message. Such a system reduces system efficiency and bandwidth. Other systems such as QUICKPLACE 1.0 are implemented using ActiveX components. As known in the art, an ActiveX component is a program that is downloaded to the client's (e.g., the sender's) computer. When requiring the sender to download the ActiveX components, numerous issues are raised. For example, ActiveX components will only function in conjunction with Win32 platforms. Thus, Web browser programs such as NETSCAPE and operating systems such as LINUX will not properly support the needed ActiveX components to attach the desired files. Moreover, whenever a sender downloads a program, security issues are raised. To this extent, many companies have policies preventing the downloading of programs and the like. In such an event, the sender will not even be able to obtain the necessary ActiveX components to make the attachment system function properly.

Other previous attachment systems that are not based on downloading ActiveX components or other “attachment” programs also have drawbacks. For example, the file attachment system implemented by YAHOO.COM provides an interface having three fields for identifying addresses of files to be attached to an electronic mail message. Such a system strictly limits the quantity of files that the sender can attach to the electronic message to three. Thus, the attachment of files is limited by quantity instead of total file size, a highly inefficient approach.

In view of the foregoing, there exists a need for a method, system, program product and interface that allows a user to upload one or more files (e.g., to a server for attachment to an electronic message) without requiring “attachment” components or programs to be downloaded. A further need exists for such a system that does not designate a fixed quantity of files that can be attached. Still yet, a need exists for all files designated for attachment to be simultaneously uploaded in a single posting.

### SUMMARY OF THE INVENTION

In general, the present invention provides a method, system, program product and DHTML-based interface for uploading multiple files to a server or the like (e.g., for attachment to an electronic message, for virus scanning, etc.) in a single posting. Specifically, the DHTML-based interface includes a first file field for identifying an address corresponding to a first file to be uploaded. Once identified, the address can be added to a list of uploads in the DHTML-based interface. After being added, the first file field will be hidden and a new, second file field will be displayed for identifying an address corresponding to a second file to be uploaded. Upon identification of the address for the second file, and subsequent addition thereof to the list of uploads, both files can be uploaded in a single posting. Thus, the present invention not only provides for file upload without having to download special components or programs, but it also allows any quantity of files to be designated for upload. In addition, since uploaded in a single posting, all files that are designated for upload are uploaded simultaneously.

According to a first aspect of the present invention, a method for uploading files in a single posting using a DHTML-based interface is provided. The method comprises: (1) displaying a first file field in the DHTML-based interface; (2) identifying an address corresponding to a first file in the first file field; (3) hiding the first file field after adding the address; and (4) displaying a second file field in the DHTML-based interface after hiding the first file field.

According to a second aspect of the present invention, a DHTML-based interface for uploading files in a single posting is provided. The DHTML-based interface comprises: (1) a first file field for identifying an address corresponding to a first file to be uploaded; and (2) a list of uploads, wherein the first file field is hidden upon addition of the address to the list of uploads, wherein a second file field for identifying an address corresponding to a second file to be uploaded is displayed in the interface after the first file field is hidden, and wherein the first file and the second file are uploadable in a single posting.

According to a third aspect of the present invention, a system for uploading files using a DHTML-based interface is provided. The system comprises: (1) a display system for displaying a DHTML-based interface having a first file field for identifying an address corresponding to a first file to be uploaded; (2) a listing system for adding the address to a list of uploads displayed in the DHTML-based interface; (3) a field hiding system for hiding the first file field after the address is added to the list of uploads, wherein a second file field for identifying an address corresponding to a second file to be uploaded is displayed in the DHTML interface after the first file field is hidden; and (4) a posting system for uploading the first file and the second file in a single posting.

According to a fourth aspect of the present invention, a program product stored on a recordable medium for uploading files using a DHTML-based interface is provided. When executed, the program product comprises: (1) program code for displaying a DHTML-based interface having a first file field for identifying an address corresponding to a first file to be uploaded; (2) program code for adding the address to a list of uploads displayed in the DHTML-based interface; (3) program code for hiding the first file field after the address is added to the list of uploads, wherein a second file field for identifying an address corresponding to a second file to be uploaded is displayed in the DHTML interface after the first file field is hidden; and (4) program code for uploading the first file and the second file in a single posting.

Therefore, the present invention provides a method, system, program product and DHTML-based interface for uploading files in a single posting.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a related-art attachment interface.

FIG. 2 depicts a computer system having an upload system for uploading in a single posting according to the present invention.

FIG. 3A depicts a DHTML-based upload interface having a first file address identified in a first file field according to the present invention.

FIG. 3B depicts the DHTML-based interface of FIG. 3A in which the first file address is added to a list of uploads.

FIG. 3C depicts the DHTML-based interface of FIG. 3A having a second file address identified in a second file field.

FIG. 3D depicts the DHTML-based interface of FIG. 3A in which the second file address is added to the list of uploads.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system, program product and DHTML-based upload interface for uploading multiple files to a server or the like (e.g., for attaching files to an electronic message, for virus scanning, etc.) in a single posting. As used herein, DHTML is used to refer to a combination of HTML, scripting languages such as JavaScript, and a document object model. Under the present invention, the DHTML-based interface includes a first file field for identifying an address corresponding to a first file to be uploaded to the electronic message. Once identified, the address can be added to a list of uploads in the DHTML-based interface. After being added, the first file field will be hidden and a new, second file field will be displayed for identifying an address corresponding to a second file to be uploaded. Upon identification of the address for the second file, and subsequent addition thereof to the list of uploads, both files can be uploaded in a single posting. Thus, the present invention not only provides for file upload without having to download special components or programs, but it also allows any quantity of files to be designated for upload. In addition, since uploaded in a single posting, all files that are designated for upload are uploaded simultaneously.

It should be understood that the teachings of the present invention will be explained in conjunction with the illustrative example of uploading files for attachment to an electronic message. Examples of electronic messages include electronic “mail” messages, cellular telephone short messages, instant messages, etc. However, it should be appreciated that the teachings described herein could be applied to upload/post any type of file for any reason. To this extent, the present invention may also extend to the attachment of files to a document and/or database record. Alternatively, the present invention could be used to upload a file to a Web server to perform some other action such as scanning for viruses. In addition, although the files in the illustrative example set forth herein are uploaded to a computer system or server, other variations are possible. For example, the files could be uploaded to a diskette or other type of recordable medium.

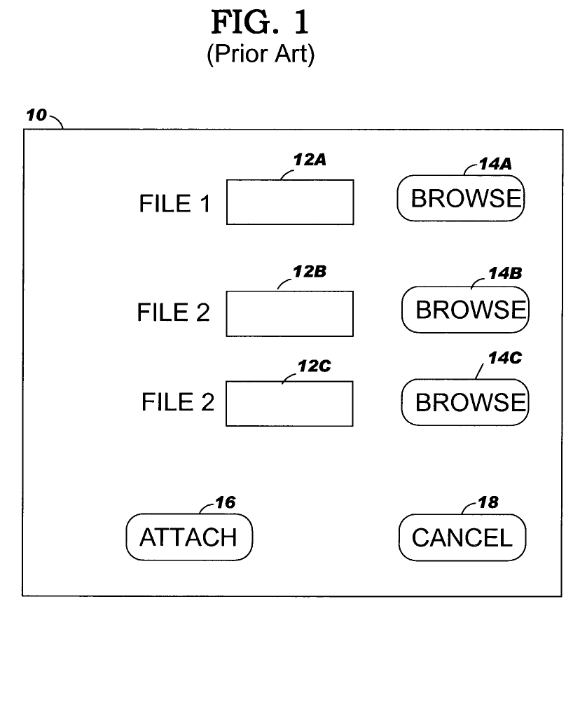

Referring now to FIG. 1, a related art “attachment” interface 10 is shown. As depicted, attachment interface 10 generally includes address fields 12A-C, browse buttons 14A-C, attach button 16 and cancel button 18. Attachment interface 10 is well known in the art and is representative of the type currently implemented by YAHOO.COM for attaching files to electronic mail messages. To this extent, it should be understood that attachment interface 10 is generally Web browser-based and is accessed through an electronic mail interface (not shown). Specifically, a user will begin to compose an electronic mail message using the electronic mail interface. If the user wishes to attach one or more files to the electronic mail message, the user will select a button or the like in the electronic mail interface, which will cause attachment interface 10 to be displayed. To attach files to the electronic mail message, the user will identify addresses for up to three files in address fields 12A-C, respectively. The addresses are generally directory addresses where the desired files are stored. In the event that the user does not know the specific address of a file, he/she can select browse buttons 14A-C to search the available directories. This process is well known in the art. Once the user has identified up to three addresses, he/she can attach the files to the electronic mail message using attach button 16. Alternatively, the user could cancel the attachment process by selecting cancel button 18.

Numerous problems exist with interfaces such as attachment interface 10. For example, attachment interface 10 is implemented using hypertext markup language (HTML). As such attachment interface 10 limits attachments based on file quantity (e.g., three). Limiting attachments based on file quantity rather than total file size fails to provide the user with maximum attachment capabilities. For example, an electronic messaging system could have the capability to deliver a message having attachments up to 1.0 megabytes in total size. However, in the case of attachment interface 10, even if the user has attached three files with a combine size 0.5 megabytes, no further attachments will be permitted.

Although other interfaces such as the attachment interface provided by HOTMAIL.COM limit attachments based on combined file size, they have other drawbacks. Specifically, such interfaces require each file to be attached to the electronic message in separate postings, a highly inefficient approach.

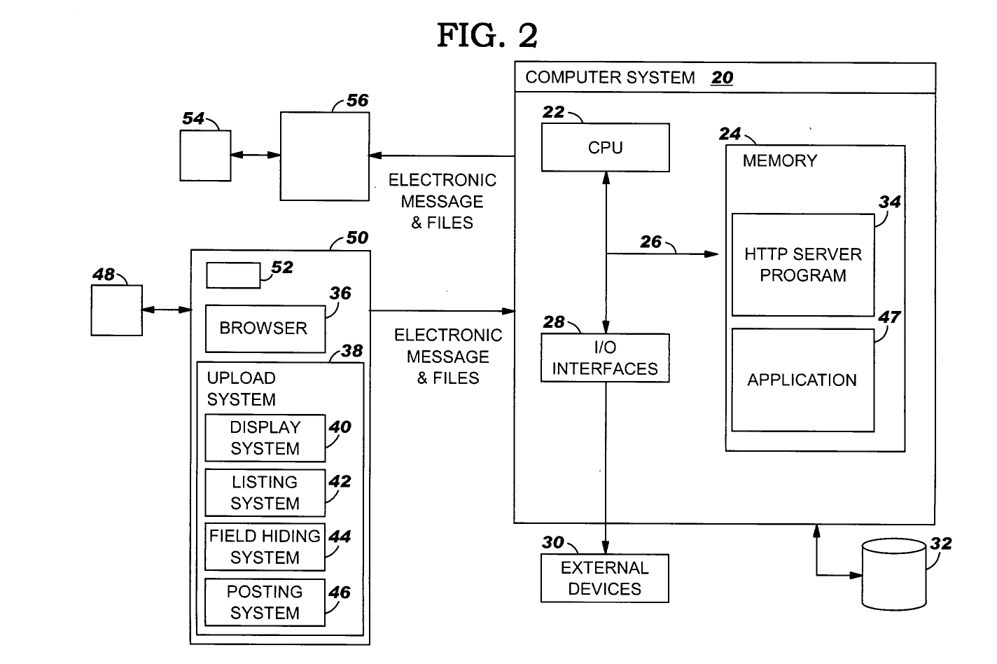

Referring now to FIG. 2, computer system 20, having HTTP server program 34 and application 47 is shown. In general, computer system 20 is intended to represent any type of computerized system capable of communicating with user 48. For example, computer system 20 could be a HTTP server. Computer system 20 could also be an electronic mail server used by an electronic mail provider. To this extent, user system 50 is intended to represent any type of computerized system that can be manipulated by user 48 to upload files to computer system 20 over a network such as the World Wide Web. Examples of user systems include, among other things, a personal computer, a workstation, a personal digital assistant, a cellular telephone, etc. It should be understood that in the event the teachings described herein are used by user 48 to attach one or more files to an electronic message intended for another user 54, user 54 would typically operate another user system 56. This other user system 56 could be manipulated by user 54 to receive the electronic message and possibly generate electronic messages of his/her own.

As shown, computer system 20 generally comprises central processing unit (CPU) 22, memory 24, bus 26, input/output (I/O) interfaces 28, external devices/resources 30 and database 32. CPU 22 may comprise a single processing unit, or be distributed across one or more processing units in one or more locations, e.g., on a client and server. Memory 24 may comprise any known type of data storage and/or transmission media, including magnetic media, optical media, random access memory (RAM), read-only memory (ROM), a data cache, a data object, etc. Moreover, similar to CPU 22, memory 24 may reside at a single physical location, comprising one or more types of data storage, or be distributed across a plurality of physical systems in various forms.

I/O interfaces 28 may comprise any system for exchanging information to/from an external source. External devices/resources 30 may comprise any known type of external device, including speakers, a CRT, LED screen, hand-held device, keyboard, mouse, voice recognition system, speech output system, printer, monitor, facsimile, pager, etc. Bus 26 provides a communication link between each of the components in computer system 20 and likewise may comprise any known type of transmission link, including electrical, optical, wireless, etc. In addition, although not shown, additional components, such as cache memory, communication systems, system software, etc., may be incorporated into computer system 20. It should also be understood that although not shown for brevity purposes, user systems 50 and 56 typically include components (e.g., CPU, memory, bus, I/O interfaces, external devices, etc.) similar to computer system 20.

Database 32 is optional and could provide storage for information such as, for example, electronic messages transmitted by user 48, attachments sent with electronic messages, etc. As such, database 32 may include one or more storage devices, such as a magnetic disk drive or an optical disk drive. In another embodiment, database 32 includes data distributed across, for example, a local area network (LAN), wide area network (WAN) or a storage area network (SAN) (not shown). Database 32 may also be configured in such a way that one of ordinary skill in the art may interpret it to include one or more storage devices.

It should be understood that communication between computer system 20 and user 48 can occur via a direct hardwired connection (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Stored in memory 24 of computer system 20 is HTTP server program 34 and application 47. HTTP server program 34 is well known in the art and is typically used to generate and serve Web pages (e.g., dynamic or static) for Web users 48 and 54. HTTP server program 34 also includes logic to handle HTTP requests from browsers (e.g., POST or GET requests). To this extent, if user 48 is sending electronic messages to user 54, HTTP server program 34 receives POST requests from user system 50, and GET requests from user system 56. Application 47 is intended to represent any program that performs some operation on uploaded files. For example, application 47 could be an electronic mail-based program that an electronic mail server uses to attach uploaded files to messages. Alternatively, application 47 could be a program that scans uploaded files for viruses.

Loaded on user system 50 (e.g., in memory) is browser (program) 36 and upload system 38. Browser 36 is intended to represent any type of Web browser that is capable of displaying DHTML. Under the present invention HTTP server program 34 will return a Web page to user system 50 that is viewed by user 48 via browser 36. Under the present invention, the returned Web page will include program code, namely, upload system 38. Upload system 38 provides a DHTML-based attachment/upload interface 52 (hereinafter “interface 52) for attaching files to an electronic message. Specifically, as shown, upload system 38 includes display system 40, listing system 42, field hiding system 44 and posting system 46. Upload system 38 will generate and display a DHTM-based attachment interface 52, which will allow user 48 to upload one or more files (e.g., for attachment to the message being composed).

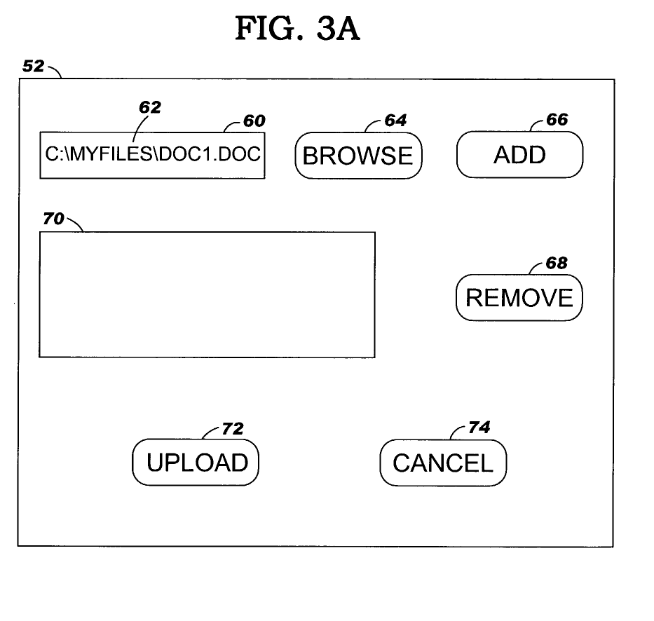

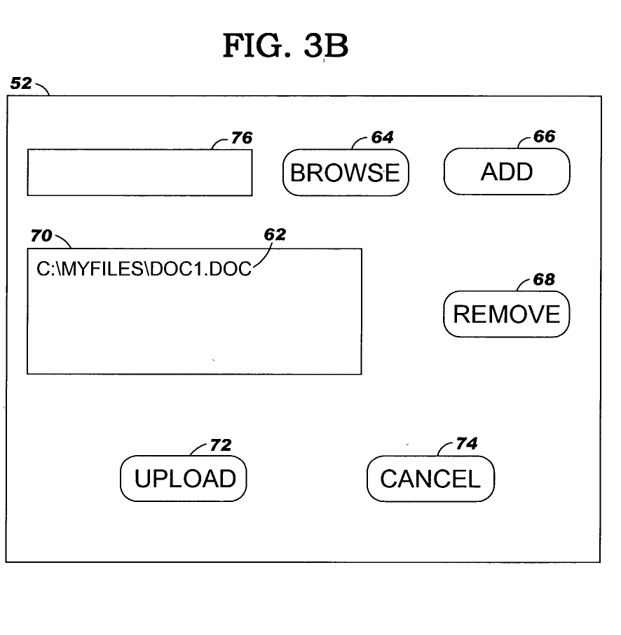

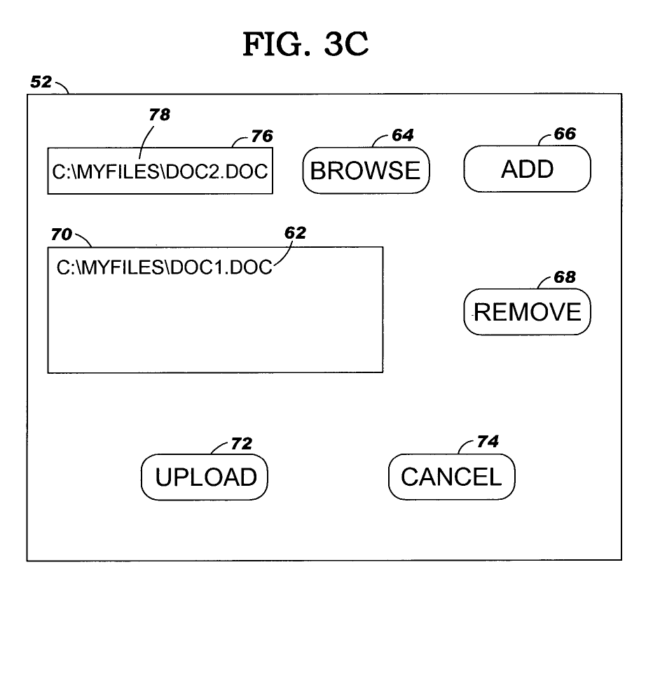

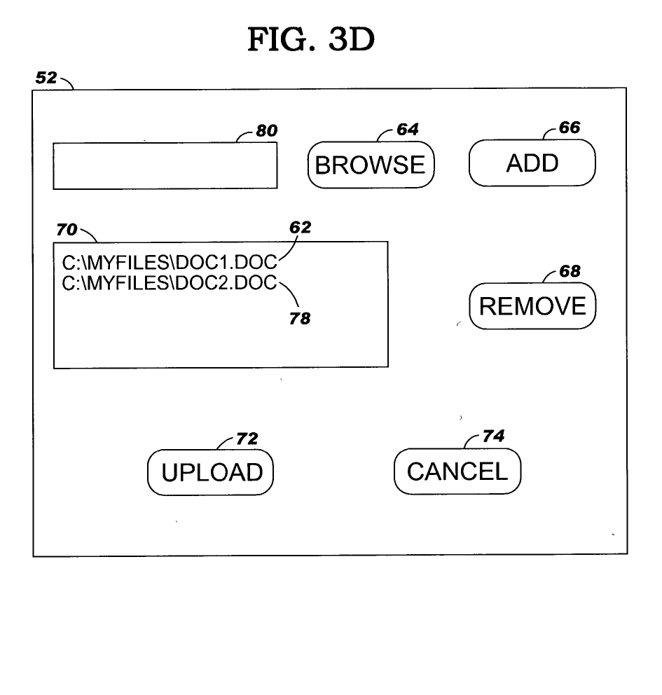

Referring to FIG. 3A, interface 52 is shown in greater detail. Specifically, interface 52 is generated and displayed by display system 40 when user 48 expresses a desire to upload one or more files. As depicted, interface 52 includes first file field 60, browse button 64, add button 66, remove button 68, list of uploads 70, upload button 72 and cancel button 74. By implementing interface 52 of the present invention using DHTML, functionality not previously available is provided. For instance, DHTML-based interface 52 does not require downloadable components, and does not limit attachment based on a specific file quantity. Moreover, any files that are to be uploaded to computer system 20 are uploaded in a single posting (i.e., simultaneously). Thus, interface 52 addresses the drawbacks inherent in other attachment interfaces.

For illustrative purposes only, the functions of the present invention will be described in conjunction with the attachment of files to an electronic message. That is, files are uploaded to computer system 20 in a single posting for attachment to an electronic message. However, as indicated above, this scenario is only one situation in which the present invention can be utilized. It should be appreciated that the present invention can be applied to the uploading of files in a single posting for any purpose.

To attach a first file to an electronic message (or “designate” a first file for upload to computer system 20), user 48 will identify address 62 corresponding thereto in first file field 60. In the event user 48 cannot recall the address, user 48 can select browse button 64 to make a search of available (e.g., local) directories. Once address 62 has been identified in first file field 60, user can add address 62 to list of uploads 70 by selecting add button 66. Specifically, upon selection of add button 66, listing system 42 (FIG. 2) will add address 62 to list of uploads 70. List of uploads 70 displays the addresses for all files user 48 indicates he/she wishes to upload (e.g., attach to the electronic mail message). This provides user 48 with a clear indication of all files he/she has expressed an interest in attaching to the electronic message. In the event user 48 decides to remove address 62 from list of uploads 70, listing system 42 will do so upon selection of remove button 68. As will be further described below, posting system 46 (FIG. 1) will upload all files whose address is identified in list of uploads 70 to computer system 20 upon selection of upload button 72.

Upon addition of address 62 to list of uploads 70, field hiding system 44 (FIG. 1) will “hide” first file field 60. That is, field hiding system 44 will remove first file field 60 from the view of user 48. Then, as shown in FIG. 3B, once first file field 60 is hidden, display system 40 will generate and display a new, second file field 76. Thus, first file field 60 is not simply “cleared” of content. Rather, it is hidden and new, second file field 76 is generated and displayed. It should be understood that browse button 64 could be linked with file field 60 as a single unit. In this case, a new, second browse button (not shown) would be generated and displayed along with new, second file field 76 in FIG. 3B.

Other interfaces that allow addition of an address to a list of attachments/uploads, such as the interface implemented by HOTMAIL.COM, actually post one file at a time to the HTTP server program, and then generate an entirely new page with the previously posted file address displayed in the list of attachments/uploads. Thus, there is no hiding of the file field or gathering of all the file addresses and posting them all to the server at once. Such an approach can be especially problematic if user 48 loses his/her Internet connection because the new Web page cannot be received on the user's system.

As shown in FIG. 3C, once second file field 76 is displayed, user 48 can identify address 78 corresponding to a second file to be attached to the electronic message. Similar to the first address 62, second address 78 can be identified manually or by browsing via browse button 64. It should also be understood that the use of DHTML in creating interface 52 could provide user 48 with the capability to drag and drop file addresses into file fields 60 and/or 76. For example, if user 48 browsed for the first file's address, user 48 could have dragged an icon corresponding to the first file from a Windows Explorer window, or the like, and dropped the icon in file fields 60 (or anywhere else in interface 52). This dragging and dropping of the icon would result in the address from which the icon was dragged being inserted in file field 60.

In any event, as shown in FIG. 3D, once user 48 has identified address 78 in second file field 76, address 78 could be added to list of uploads 70 by selecting add button 66 (similar to address 62). Just as the addition of address 62 caused first file field 60 to be hidden and second file field 76 to be displayed, the addition of address 78 to list of uploads 70 would result in second file field 76 being hidden and third file field 80 being displayed. Similar to first file field 60, second file field 76 could have been linked to browse button 64. In such a case, a new browse button (not shown) would be generated and displayed with third file field 80. In any event, user 48 can continue to manipulate interface 52 in this manner until user 48 has identified all files he/she wishes to attach to the electronic message.

Upon selection of upload button 72, all files whose addresses are identified in list of uploads 70 will be uploaded to computer system 20 for attachment to the electronic message. If, however, user 48 decides not to attach one of the files, user 48 can selectively remove the corresponding address from list of uploads 70 by highlighting the corresponding address in list of addresses 70 and then selecting remove button 68. If an address is removed, the corresponding hidden file field will be deleted. Moreover, if user 48 decides to cancel all attachments all together, user 48 can do this by selecting cancel button 74. In the event user 48 selects upload button 72, posting system 44 of FIG. 1 will upload the files in a single posting. That is, all files identified for attachment will be simultaneously uploaded to computer system 20. Uploading the files in a single posting avoids the inefficiencies of having to make separate postings for each file. Moreover, interface 52 does not limit user 48 to a particular quantity of files. Once uploaded to computer system 20, application 47 will actually attach the files to the electronic message (in any way now known or later developed).

It should be understood that interface 52 provides user 48 with the capability to attach as many files as desired (up to any applicable size limitation for a single posting). A process for attaching two files has been described herein for illustrative purposes only and should not be construed as limiting. It is further understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 20 such that it carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. To this extent, although a specific depiction of upload system 38 and its subsystems have been depicted and described, the functionality described herein could be implemented in any number of ways. For example, one or more systems and/or subsystems shown could be combined into a single system and/or subsystem (e.g., browser and upload system 38). Moreover, although the functionality of the present invention described herein has been associated with specific subsystems of upload system 38, other implementations could exist. For example, when listing system 42 adds an address to list of uploads 70, field hiding system could be responsible for both hiding the old file field, and generating the new file field. In this case, display system 40 would display the new file field (as opposed to generating and displaying the new file field). Still yet, it should be understood that the labels shown in conjunction with interface 52 are illustrative only and other variations could be implemented. For example, upload button 72 could be labeled as attach button 72.

We claim:

1. A method for uploading files in a single posting using a DHTML-based interface, comprising:
displaying a first file field in the DHTML-based interface;
identifying an address corresponding to a first file in the first file field;
hiding the first file field after adding the address; and
displaying a second file field in the DHTML-based interface after hiding the first file field.

2. The method of claim 1, further comprising uploading the first file to a server.

3. The method of claim 2, further comprising attaching the uploaded file to an electronic message.

4. The method of claim 1, further comprising:
identifying an address corresponding to a second file in the second file field; and
uploading the first file and the second file to a server in the single posting.

5. The method of claim 4, further comprising:
adding the address corresponding to the first file to a list of uploads in the DHTML-based interface prior to the hiding step; and
adding the address corresponding to the second file to the list of uploads prior to the attaching step.

6. The method of claim 4, wherein the address corresponding to the first file is added to the list of uploads by selecting an add button in the DHTML-based interface, and wherein the address corresponding to the second file is added to the list of uploads by a subsequently selecting the add button.

7. The method of claim 4, wherein the first file and the second file are uploaded in the single posting by selecting an upload button in the DHTML-based interface.

8. A DHTML-based interface for uploading files in a single posting, comprising:
a first file field for identifying an address corresponding to a first file to be uploaded; and
a list of uploads, wherein the first file field is hidden upon addition of the address to the list of uploads, wherein a second file field for identifying an address corresponding to a second file to be uploaded is displayed in the interface after the first file field is hidden, and wherein the first file and the second file are uploadable in a single posting.

9. The DHTML-based interface of claim 8, wherein the first file and the second file are uploaded to a server.

10. The DHTML-based interface of claim 8, wherein the first file and the second file are attached to an electronic message.

11. The DHTML-based interface of claim 8, further comprising an add button for adding the address corresponding to the first file and address corresponding to the second file to the list of uploads.

12. The DHTML-based interface of claim 8, further comprising an upload button for uploading the first file and the second file in the single posting.

13. A system for uploading files using a DHTML-based interface, comprising:
a display system for displaying a DHTML-based interface having a first file field for identifying an address corresponding to a first file to be uploaded;
a listing system for adding the address to a list of uploads displayed in the DHTML-based interface;
a field hiding system for hiding the first file field after the address is added to the list of uploads, wherein a second file field for identifying an address corresponding to a second file to be uploaded is displayed in the DHTML interface after the first file field is hidden; and
a posting system for uploading the first file and the second file in a single posting.

14. The system of claim 13, wherein the first file and the second file are uploaded to a server, and wherein the first file and the second file are attached to an electronic message after being uploaded.

15. The system of claim 13, wherein the DHTML-based interface further comprises an add button for adding the address corresponding to the first file and address corresponding to the second file to the list of uploads.

16. The system of claim 13, wherein the DHTML-based interface further comprises an upload button for uploading the first file and the second file in the single posting.

17. A program product stored on a recordable medium for uploading files using a DHTML-based interface, comprising:
program code for displaying a DHTML-based interface having a first file field for identifying an address corresponding to a first file to be uploaded;
program code for adding the address to a list of uploads displayed in the DHTML-based interface;
program code for hiding the first file field after the address is added to the list of uploads, wherein a second file field for identifying an address corresponding to a second file to be uploaded is displayed in the DHTML interface after the first file field is hidden; and
program code for uploading the first file and the second file in a single posting.

18. The program product of claim 17, wherein the first file and the second file are uploaded to a server, and wherein the first file and the second file are attached to an electronic message after being uploaded.

19. The program product of claim 17, wherein the DHTML-based interface further comprises an add button for adding the address corresponding to the first file and address corresponding to the second file to the list of uploads.

20. The program product of claim 17, wherein the DHTML-based interface further comprises an upload button for uploading the first file and the second file in the single posting.
